(19) United States
(12) Patent Application Publication
(10) Pub. No.: US 2012/0089471 A1
(43) Pub. Date: Apr. 12, 2012

(54) SYSTEM AND METHOD OF CAPTURING POINT-OF-SALE DATA AND PROVIDING REAL-TIME ADVERTISING CONTENT

(75) Inventor: Antonio COMPARELLI, Thornhill (CA)

(73) Assignee: RT7 INCORPORATED, Toronto (CA)

(21) Appl. No.: 13/105,638

(22) Filed: May 11, 2011

Related U.S. Application Data
(63) Continuation-in-part of application No. 12/899,014, filed on Oct. 6, 2010.

(51) Int. Cl. G06Q 20/00

(52) U.S. Cl. 705/18; 705/21; 705/17; 705/24

(57) ABSTRACT

A tap device is provided for mobile device payment at a point-of-sale (POS) terminal. The tap device monitors at least one communication line of the POS terminal and detects at least one data packet having transaction data. The tap device includes a trigger database having entries including pre-stored trigger data elements. A first processor compares the pre-stored trigger data elements with the transaction data. The tap device transmits the transaction data when at least a portion of the transaction data corresponds to at least one pre-selected trigger data element. The tap device includes a first receiver receiving a Quick Response (QR) code generated by a remote server in response to the transaction data. The QR code includes an encoding of the transaction data. The tap device includes a display displaying the QR code for image capture by a mobile device that decodes the captured QR code into the transaction data.

### CROSS-REFERENCE TO RELATED APPLICATION

This application is a Continuation-in-Part-of and claims priority from pending U.S. Utility patent application Ser. No. 12/899,014, filed Oct. 6, 2010 entitled SYSTEM AND METHOD OF CAPTURING POINT-OF-SALE DATA AND PROVIDING REAL-TIME ADVERTISING CONTENT, the entire contents of which are incorporated herein by reference.

### STATEMENT REGARDING FEDERALLY SPONSORED RESEARCH OR DEVELOPMENT

n/a

### FIELD OF THE INVENTION

The invention relates to systems and methods of delivering content. More particularly, the invention relates to systems and methods of delivering content at a point-of-sale/service (“POS”) terminal. More particularly, the invention relates to systems and methods of delivering content, such as digital messages, in real-time at a POS terminal in response to purchase transaction data. More particularly, the invention relates to systems and methods for mobile device payment at a POS terminal.

### BACKGROUND OF THE INVENTION

Discount coupons are well-known in the retail goods industry to promote the sale of specific goods to consumers. Known coupon or promotion distribution is performed using mass distribution techniques. These techniques do not efficiently target coupon delivery to desired consumers, such as consumers most likely to remit the discount coupons. Distribution techniques have evolved to trigger coupon delivery based on consumer behavior. For example, known systems deliver proprietary digital content, such as printed sales receipts, to consumers based on information obtained at point-of-sale/service (“POS”) terminals. Furthermore, known systems use proprietary formats to deliver the proprietary digital content to consumers.

As a result, known systems restrict a retailer's ability to display non-proprietary digital content to consumers. To overcome this deficiency, existing systems employ extensive software or hardware modifications to display the non-proprietary digital content. Alternatively, the non-proprietary digital content may be converted to a proprietary format before display on existing systems. In the absence of software modification, hardware modification or data conversion, known systems are incapable of displaying non-proprietary digital content. Thus, retailers are unable to display non-proprietary digital content at an expense of foregoing media revenue and/or advertising revenue. What is needed is a system and method of displaying all types of digital content at POS terminals, without needing to modify the POS terminals.

Also, retail environments having POS terminals are continually seeking ways to enable consumers to more conveniently and promptly pay for goods or services. Typical retail stores have an employee operating the POS terminal at a check-out line. When all the consumer's items have been scanned, the consumer is prompted for payment. At this point, the consumer may typically pay by credit/debit card by sliding the card through a card reader or pay with cash. These payment methods require the consumers to dig through their pant pocket or a purse to find the appropriate card or amount of cash. In particular, both of these methods are time consuming and hold up the check-out line, thereby thwarting a consumer's pleasant shopping experience. Moreover, at the check-out line, some consumers realize they left their credit/debit cards or cash at home or in the car, thereby further holding up the check-out line. These payment methods serve to generate check-out line congestion.

Some retail environments tackle the problem of check-out line congestion and wait times by adding additional POS terminals. For example, self-checkout POS terminals allow consumers to self-scan items and pay for the items in the same manner as an employee operated POS terminal. While additional checkout terminals may ease some of the check-out traffic and wait times, this method fails to address the underlying problem, current consumer payment methods are time consuming. Also, the cost of adding or upgrading hardware and software to integrate seamlessly into an existing POS terminal is often substantial, i.e., POS terminal hardware upgrades may also require software upgrades. What is needed is a system and method of paying at a POS terminal that incorporates and synchronizes a consumer's mobile device to allow fast check-out at a POS terminal.

### SUMMARY OF THE INVENTION

The invention advantageously provides a method and system for automatically delivering digital messages for presentation to consumers on digital displays, without any modification of existing point-of-sale systems or electronic cash registers.

According to one embodiment, a tap device is provided that monitors data communications with a point-of-service terminal device. The tap device communicates with remote servers that are associated with an external network, a local server that is associated with an internal network and a display for displaying point-of-purchase promotional media. The tap device includes a monitoring device that monitors communication lines of the point-of-service terminal device for data packets having sales transaction data. The tap device includes a trigger database having entries with pre-stored digital message trigger data elements and a processor that communicates with the monitoring device to receive the sales transaction data. The processor generates instructions to search the entries of the trigger database for a match between the pre-stored digital message trigger data elements and the sales transaction data. The tap device includes an engine that releases selected digital messages to the display upon receiving a signal from the processor identifying a match.

According to another embodiment, a point-of-sale system is provided in an environment having a plurality of stores that are associated with two or more organizations. The point-of-sale system includes a plurality of in-store networks that are associated with the plurality of stores and with at least one of the two or more organizations. The plurality of in-store networks include a tap device that monitors data communications with a corresponding point-of-service terminal device. The tap device assigns a unique identifier to sales transaction data associated with the tap device and the corresponding in-store network. An information server is provided to communicate with the tap device to obtain the sales transaction data and the unique identifier. The information server includes an aggregation device that aggregates the sales transaction data associated with the two or more organizations based on the unique identifier and a segregation device that separates the sales transaction data associated with the two or more organizations based on the unique identifier. The information server also includes a control device that enables the two or more organizations to control access to the corresponding sales transaction data. A digital message server is provided to communicate with the information server and the tap device, the digital message server delivering digital messages to the tap device for display to users.

According to yet another embodiment, a method is provided of automatically delivering digital messages to consumers at a point-of-sale location, without modifying existing point-of-service terminal devices. The method includes monitoring data transmitted between the point-of-service terminal device and an output device for predefined unique markers and capturing the data having the predefined unique markers using a tap device. The captured data is compared against digital message trigger data elements stored in a trigger database to identify a match between the captured data and the digital message trigger data elements. If a match is identified, selected digital messages are released to a display associated with the tap device. The selected digital images include a plurality of audio or video file types.

According to yet another embodiment, a tap device is provided for mobile device payment at a point-of-sale/service (POS) terminal. The tap device includes a monitor module monitoring at least one communication line of the POS terminal and detecting at least one data packet having transaction data. The tap device includes a trigger database having entries including pre-stored trigger data elements, in which a first processor receives the transaction data and compares the pre-stored trigger data elements with the transaction data. The first processor generates instructions to transmit the transaction data to a remote server when at least a portion of the transaction data corresponds to at least one pre-selected trigger data element. The tap device includes a first receiver receiving a Quick Response (QR) code generated by the remote server in response to the transaction data, in which the QR code includes an encoding of the transaction data. The tap device includes a display displaying the QR code for image capture by a mobile device that decodes the captured QR code into the transaction data.

According to yet another embodiment, a system is provided for mobile device payment at a point-of-sale/service (POS) terminal. The system includes a tap device having a monitor module monitoring at least one communication line of the POS terminal. The monitor module detects at least one data packet having transaction data, in which the transaction data includes a payload identifier indicating a mobile device payment transaction. The tap device includes a trigger database having entries including pre-stored trigger data elements, in which a first processor receives the transaction data and compares the pre-stored trigger data elements with the transaction data. The first processor generates instructions to transmit the transaction data to a remote server when at least a portion of the transaction data matches at least one pre-selected trigger data element. The tap device includes a first receiver receiving a token from the remote server responsive to the transaction data. The tap device includes a display displaying the token.

According to yet another embodiment, a method is provided for mobile device payment at a point-of-sale/service (POS) terminal device. The method includes monitoring at least one communication line of the POS terminal device and detecting at least one data packet having transaction data. The method also includes displaying a generated Quick Response (QR) code in response to the transmitted data for image capture, in which the QR code includes an encoding of the transaction data.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 illustrates a system diagram according to one embodiment of the invention;

FIG. 2 illustrates a system diagram according to a second embodiment of the invention;

FIG. 3 illustrates a flow chart for automatically displaying digital messages to consumers at a point-of-service terminal, regardless of message format; and

FIGS. 4A, 4B illustrate a flow chart for mobile device payment at a point-of-service terminal.

### DETAILED DESCRIPTION OF THE INVENTION

Retailers continue to seek ways to expand point-of-purchase promotional media opportunities. The present invention provides devices that add functionality to existing point-of-sale/service (“POS”) retail management systems, such as computer based POS terminals and electronic cash register systems, among other devices. The invention provides the additional functionality without modifying software or hardware components of these POS retail management systems. According to one embodiment, the invention displays point-of-purchase promotional media on digital displays integrated directly into the POS or electronic cash register systems. According to another embodiment, the invention displays a generated visual token that is decoded by a mobile device in order to synchronize the POS retail management system with the mobile device, thereby allowing for mobile device payment.

POS retail management systems are used in various environments, including retail hard good environments, grocery environments, soft good environments, brown good environments and quick service environments, among other environments. POS retail management systems operate to manage inventory, process sales transactions, tender payment and record transactional activity, among performing other functions. POS retail management systems provide various output options, including generating printed sale receipts upon completion of sales transactions.

The invention provides a tap device positioned between the POS terminal and the output device, such a receipt printer, to passively gather or “wiretap” data transmitted between these devices. The tap device may be removably coupled to these devices. Furthermore, the tap device does not modify the operation of or the interaction between the POS terminal and the output device, even during a tap device failure. In other words, the tap device streams data between the POS terminal and the output device, regardless of its operation state.

According to one embodiment, the output device may be coupled to the POS terminal through an interface, such as a serial port, a parallel port or a Universal Serial Bus (“USB”) port, among other interfaces. If the POS terminal outputs data in serial format to the output device, the interface may include a serial-to-USB data converter that sends monitored data in serial form through the USB interface to the tap device. If the POS terminal outputs data in a serial format via USB port to the output device, the interface may include a USB data tap that monitors the serial data transmitted to the tap device. The tap device may include a video connection that displays digital messages to an in-store digital display.

While specific embodiments of the invention are discussed herein and are illustrated in the figures appended hereto, the invention encompasses a broader spectrum than the specific subject matter described and illustrated. As would be appreciated by those skilled in the art, the embodiments described herein provide but a few examples of the broad scope of the invention. There is no intention to limit the scope of the invention only to the embodiments described.

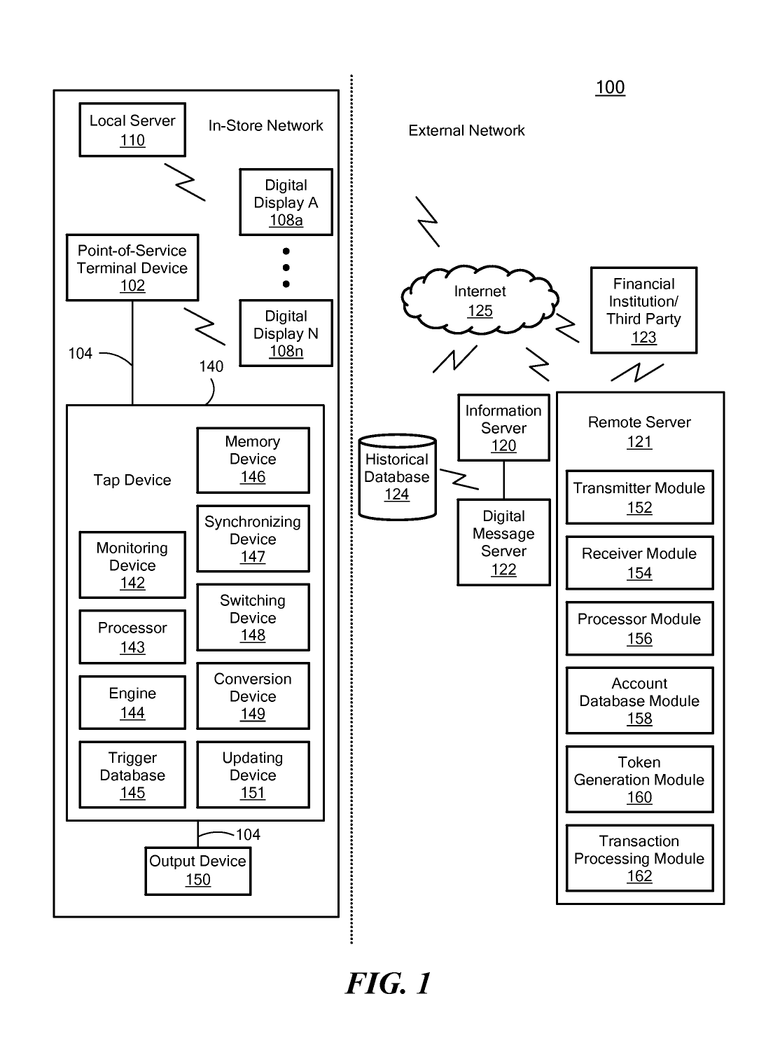

FIG. 1 illustrates an example of system architecture 100 according to one embodiment of the invention. The POS terminal 102 may be communicatively coupled to one or more local servers 110 and/or to one or more remote servers, including an information server 120, remote server 121 and a digital message server 122, among other servers. A historical database 124 may be provided to communicate with the remote servers to archive sales data, among other data. The POS terminal 102 may be communicatively coupled to the system architecture 100 via a wired network, a wireless network, or a combination of the foregoing and/or other networks, including the Internet 125. The POS terminal 102 may be coupled to an output device 150, such as a printer, imaging device or other output device. The tap device 140 may be positioned between the POS terminal 102 and the output device 150 to monitor and/or capture data, including sales transaction data, passing between these devices, among performing other functions.

The local server 110 and the remote servers are communicatively coupled to capture, store, and forward data communications to the POS terminal devices 102. According to one embodiment, the local server 110 may be an in-store server that stores sales receipt information, including product assigned identification codes, such as price look up (“PLU”) codes and stock keeping unit (“SKU”) codes, among other product codes. The local server 110 also may store information associated with product descriptions; inventory data, including product quantity amounts; purchase price data; payment method data; total value of the sale data, including sub-total and total amounts; transaction date; transaction time; transaction location, including store data and POS terminal device data; retail establishment type; and retail establishment categories; among other information.

The tap device 140 may be of modular construction to facilitate adding, deleting, updating and/or amending modules therein and/or features within modules. The modules may include hardware components, such as a monitoring device 142, a processor 143, an engine 144, a trigger database 145, a memory device 146, a switching device 147, a synchronizing device 148, a conversion device 149, an updating device 151, or other modules. It should be readily understood that a greater or lesser number of modules might be used. One skilled in the art will readily appreciate that the invention may be implemented using individual modules or a single module that incorporates the features of two or more separately described modules, among other configurations.

The tap device 140 may include a monitoring device 142 that monitors communication lines 104 for data signals, passing between the POS terminal 102 and the output device 150. According to one embodiment, the monitoring device 142 monitors data packets traversing the data lines 104. The data packets may include markers that uniquely identify data packet types and may also include sales transaction data. For example, the markers may include codes that correspond to predefined events, such as a start/termination of purchase transactions. The sales transaction data may include product identification codes; manufacturer information; product quantity amounts; purchase price data; payment method data; total value of the sale data; transaction location such as Global Positioning System coordinates of the POS terminal; retailer categories, including clothing retailer, shoe retailer, food retailer, among other retailer categories; product description information, including searching text provided in the product description (e.g., 100 oz. bottle of sun screen) obtained from the product identification codes. The sales transaction data may also include a payload identifier, transaction type, terminal identification (ID), transaction number, date/time of transaction, among other data. In particular, the payload identifier may identify sales transaction data as a unique mobile payment transaction, credit card payment transaction, cash payment transaction and the like. The transaction type data may indicate the type of transaction such as a sale, refund, exchange and the like. The terminal ID may identify the retailer or merchant by a specific identification code, merchant number and the like. The transaction number may be the specific identification number given to the transaction. The date/time of the transaction may indicate the particular date and time when the transaction was initiated, completed and the like.

The tap device 140 may include a processor 143 that communicates with the monitoring device 142 and generates instructions for performing selected actions upon receiving the codes. According to one embodiment, the selected actions may be performed in real-time. For example, the processor 143 may instruct an engine 144 located within the tap device 140 obtain the sales transaction data and to send preselected digital content to the digital displays 108a-108n (hereinafter referred to as “digital displays 108”) or the processor may instruct the engine 144 to obtain sales transaction data and send it to the remote server 121, among performing other actions. In another example, the digital displays 108 may display received messages from the remote server 121 such as QR codes and mobile device payment status, among other types of messages. The digital displays 108 may be positioned proximate to the corresponding POS terminals 102 to display the content to desired users. Alternatively, the tap device 140 may include at least one digital displays 108 such that the at least one of the digital displays 108 is part of the tap device 140 as opposed to a standalone digital display. For example, a side of the tap device 140 may have a digital display for displaying advertisements and visual tokens such as QR codes, among other content.

The digital displays 108 may include any number of stand alone digital displays. Alternatively, the digital displays 108 may include digital displays associated with different types of devices, such as personal digital assistants (PDAs), mobile devices, cell phones, personal computers, laptops, among other devices that combine the functionality of one or more of the foregoing devices. The digital displays 108 may be associated with devices that include processors, RAM, USB interfaces, telephone interfaces, satellite interface, microphones, speakers, a stylus, a computer mouse, a wide area network interface, a local area network interface, hard disks, wireless communication interfaces, a keyboard, a flat touch-screen display, and a display, among other components.

According to one embodiment, the digital displays 108 may include a touch-sensitive display screen, a handset, speakers and input buttons, among other features. Selected functions may be implemented on the digital displays 108 by positioning an indicator over selected icons and manipulating an input receiving device such as a touch-sensitive display screen, a mouse, a keyboard, a voice recognition system or other input receiving devices. The digital displays 108 may include a video input device to permit audio-visual communications. The digital displays 108 may communicate with the POS terminal 102, the local server 110, the information server 120, the digital message server 122 and/or other systems.

Upon receiving the codes and the sales transaction data, the processor 143 may access a trigger database 145 having pre-stored digital message trigger data elements and/or sales transaction trigger data elements. The digital message trigger data elements include product identification codes; manufacturer information; product quantity amounts; purchase price data; payment method data; total value of the sale data; transaction location; retailer categories, including clothing retailer, shoe retailer, food retailer, among other retailer categories; product description information, including searching text provided in the product description (e.g., 100 oz. bottle of sun screen); or a transaction start code, among other preselected digital message trigger data elements and/or sales transaction trigger data elements. The data in the trigger database 145, including the digital message trigger data elements, may be updated and managed through the information server 120 over a public network, such as the Internet 125, or a private network connection. According to one embodiment, data in the trigger database 145 may be updated and/or managed in real-time. Alternatively, the information server 120 may trigger updates to the trigger database 145 based on system resource availability, such as bandwidth availability or other system availability. The tap device 140 may include a memory device 146 that locally stores data received from the local serve 110, the remote servers and/or other data sources.

According to one embodiment, the processor 143 issues instructions for searching the trigger database entries to find one or more matches between the digital message trigger data elements and the sales transaction trigger data elements obtained from the POS terminal device 102 during a sales transaction. The processor 143 may identify a match upon detecting one or more of: preselected product details, including a product SKU, among other preselected product details; product description elements, including brand names, product size, product release (e.g., Coca Cola® Classic, 12 oz., 1999 Edition), among other product description elements; quantity purchase amounts (e.g., 6 items); purchase Price (e.g., $2.99) and/or payment information, including cash, credit card issuer (e.g., Visa®, MasterCard®), debit card, mobile device payment, among other payment information. The processor 143 may issue instructions to begin searching the trigger database upon detecting: a preselected transaction start code, a preselected category and/or a preselected location of either the retailer or the POS Terminal (Transaction Start Code, category-Convenience Store, location-10010/Manhattan), preselected transaction payment code, among other search triggers. The processor 143 may issue instructions for searching the trigger database 145 using a variety of techniques. For example, the processor 143 may issue instructions to search the trigger database 145 using a structured query language (SQL) that uses SQL statements to perform tasks.

The information server 120 and/or remote server 121 may be configured to capture data from sources coupled to the tap device 140, including the POS terminal 102 and the local server 110, among other sources. For sources that require authentication information or security credentials before granting access to the data (e.g., passwords, digital certificates, etc.), the information server 120 and/or remote server 121 may submit authentication information prior to requesting data from the target device, such as the tap device 140. One of ordinary skill in the art will readily appreciate that various authentication schemes may be employed.

During standard operating conditions, the tap device 140 and the local server 110 transmit data to and receive data from the external servers, including the information server 120, remote server 121 and/or the digital message server 122. Under these conditions, the tap device 140 may locally store data received from the internal servers and the external servers, including the information server 120, remote server 121 or the digital message server 122, among other servers. In other words, the tap device 140 may operate as a redundancy device by locally storing data in the memory device 146.

The tap device 140 may include a synchronizing device 147 that maintains data version tags for the data stored at the selected sources and the memory device 146. The data version tags may be used at the selected sources and the memory device 146 to identify the data that is stored most recent in time. According to one embodiment, the synchronizing device 147 may analyze the data version tag and determine whether to replicate data from the selected sources to the memory device 146 or from the memory device 146 to the selected sources. In this way, the synchronizing device 147 prevents the POS terminal 102 from accessing expired data.

For various reasons, the memory device 146 may be accessed or sought to be accessed by local devices, including the POS terminal 102 and the local server 110, among other local devices. As needed, the synchronizing device 147 may update the memory device 146 to include data from the remote servers in order to maintain continuity and timely data. According to one embodiment, the memory device 146 may be updated at selected schedules, including periodic schedules, random schedules, scheduling based on system resources, or other preselected schedules. For example, the memory device 146 may be structured to mirror the data structure of selected sources, such as the local server 110 and remote servers, including the information server 120 and the digital message server 122, among other sources.

Since the memory device 146 stores duplicate up-to-date data, the POS terminal 102 users do not experience a service interruption when internal and/or external communication paths are disrupted. If the memory device 146 includes incomplete data, then any data requests submitted by the POS terminal 102 may be stored in the tap device 140 and propagated to/from the tap device 140 when the selected sources are re-connected to the system. The selected sources may include the local server 110, the information server 120, remote server 121 and the digital message server.

According to one embodiment, data may be retrieved from the memory device 146 during service interruption times. Service interruptions may occur when an internal communication path between the POS terminal 102 and the local server 110 is severed. Alternatively, service interruptions may occur when an external communication path between one of the POS terminal 102 or the local server 110 and the external servers, including the information server 120, remote server 121 or the digital message server 122, are severed. One of ordinary skill in the art will readily appreciate that other service interruption conditions may occur.

The tap device 140 may include a switching device 148 that operates to switch data connections for the POS terminal 102 between selected sources and the tap device 140. The operation of switching the data connection for the POS terminal 102 between the selected sources and the tap device 140 is transparent to users of the POS terminal 102. The switching device 148 may include a detector that determines the communication status of the POS terminal 102. For example, the switching device 148 may detect whether the POS terminal 102 is operating online or offline relative to (1) an internal communication path to the local server 110 and (2) an external communication path to the external sources.

If the POS terminal 102 is determined to be operating offline relative to the external network 125, then the POS terminal 102 may be coupled to one or both of the local server 110 and the tap device 140. If the POS terminal 102 is determined to be operating offline relative to the internal network (e.g., the local server 110), then the POS terminal 102 may be coupled to one or both of the external servers and the tap device 140. Alternatively, the POS terminal 102 may be coupled solely to the tap device 140 during service interruptions.

According to one embodiment, the tap device 140 may be configured to process all types of digital media audio/video files. The digital media audio/video files may include Flash (or “SWF” files); AVI; windows media player (“WMF”) files; static digital images, including JPG, GIF, TIF, etc.; dynamic digital images (animated JPG, GIF, etc.); streaming text files; and streaming video; among other digital media audio/video files. The tap device 140 may include a conversion device 149 that converts the digital media audio/video files to preselected formats prior to storage. According to one embodiment, the digital media audio/video files may be received from the digital message server 122, among other sources.

The processor 143 may instruct the engine 144 to release corresponding digital messages when the processor 143 finds a match between the received sales transaction data and the digital message trigger data elements that are stored in at least one of the information server 120, the local server 110 or the trigger database 145. The digital messages may be release from the digital message server 122 or the memory device 146, among other sources. Any digital messages released from the digital message server 122 may be routed through the information server 120. The digital messages may be delivered to the local server 110 for processing. The local server 110 may direct the digital messages to the POS terminal 102 and/or the tap device 140 for display by the digital displays 108 or the output device, among other devices. If delivered to the POS terminal 102, the digital messages may be displayed to consumers on devices that are communicatively coupled to the POS terminal 102. If delivered to the tap device 140, the digital messages may be displayed to consumers on devices that are communicatively coupled to the tap device 140, but may not be communicatively coupled to the POS terminal 102. According to one embodiment, the digital displays 108 may provide a matrix barcode, such as a Quick Response (QR) code, that is scanned by a consumer's smart phone. The QR code may result in delivery of selected content to the consumer's smart phone. Alternatively, the digital message may be delivered to the output device 150, such as a printer or other output device. For example, selected content may be displayed based on finding one or more matches between the digital message trigger data elements and the received sales transaction data, as discussed above.

Also, the processor 143 may instruct the engine 144 to transmit sales transactions data. For example, the processor 143 may detect a match between a portion of sale transaction data and a sales transaction trigger element, indicating the consumer is initiating a mobile device payment. Upon detecting the match, the processor 143 may instruct the engine 144 to transmit at least a portion of the sales transaction data to the remote server 121 for processing.

According to one embodiment, digital messages may include content provided to retail consumers at a check out location. Digital messages may include promotional content, advertising content, news content, weather information, product information, service information, promotional materials, discount information for selected products and services or news related to a specific retailer or retail category, among other digital messages. The digital messages may be delivered and displayed in any form, including digital media audio/video files (SWF, AVI, WMF, etc.), static digital images (JPG, GIF, TIF, etc.), dynamic digital images (animated JPG, GIF, etc.), streaming text files and streaming video.

The tap device 140 may include an updating device 151 that updates the sources, including the local server 110, the information server 120, remote server 121 and the digital message server 122, among other sources. The updating device 151 may modify digital message trigger criteria and/or sales transaction trigger criteria for presenting and/or transmitting the digital messages or content associated with product identification codes, manufacturer information, product quantity amounts, purchase price data, payment method data, total value of the sale data, and transaction location, among other preselected digital message trigger data elements.

The tap device 140 may include a token generation module (not shown) that may generate a token based on the detected transaction data. The token may include a code that may be displayed on the digital displays 108, tap device display or on another display, i.e., a visual token. For example, the token generation module may generate a code encoded or embedded with some or all of the sales transaction data. The code may also include other data such as metrics, advertisements, coupons, consumer account information, among other data. In particular, the code may be a two-dimensional matrix barcode such as a Quick Response (QR) code. The QR code may consist of black modules arranged in a pattern on a white background. Specifically, the QR code may include encoded sales transaction data such as transaction type, terminal ID, transaction number, date/time of transaction, amount of transaction, GPS co-ordinates of the POS terminal 102, merchant ID, among other data. Also, the token generation module 160 may generate the code in a file format that is readable by the POS terminal 102, tap device 140, digital displays 108, among other devices. For example, the code file format may be portable network graphics (.png), portable document format (.pdf), scalable vector graphics (.svg), graphics interchange format (.gif), joint photographic experts group (.jpeg), among other file formats. Furthermore, the token generation module 160 may generate other types of codes such as micro QR code, linear barcodes, other two dimensional barcodes and other codes that are an optical machine readable representation of data. The other types of codes may include less, more or the same amount of information as the QR code. Alternatively, the token generation module 160 may be located in the remote server 121, as discussed below.

Referring to FIG. 1, the remote server 121 may include a transmitter module 152, receiver module 154, processor module 156, account database module 158, token generation module 160, transaction processing module 162, among other modules. The transmitter module 152 may transmit data packets through a network such as Internet 125, in-store network, external network, among other networks. The receiver module 154 may receive data packets from a network such as Internet 125, in-store network, external network, among other networks. The processor module 156 may include a computer processor unit (CPU) that functions in substantially the same manner as processor 143.

The remote server 121 may also include an account database module 158 that stores account information such as consumer account data, merchant account data, among other account data. For example, a consumer may register with a mobile device payment service provider via an online website. The consumer's registration information may be stored in the consumer account database. In particular, consumer account data may include name, address, personal identification number (PIN), credit/debit card information, financial institution information, mobile phone number, among other data. Each consumer's account data may be linked to the unique PIN that is assigned to the consumer or chosen by the consumer, e.g., four digit PIN. Other unique identifiers may also be used based on thumb print recognition, voice recognition, eye scanning, among other unique consumer identifiers. Also, the account database may be located at a different location than the remote server 121. Moreover, other methods of consumer account registration may be used in accordance with the invention.

The remote server 121 may include a token generation module 160 that may generate a token based on data received from the tap device 140, POS terminal 102 or other devices. The token may include a code that may be displayed on the digital displays 108, on the tap device display or on another display, i.e., a visual token, as discussed above. In particular, the code may be a two-dimensional matrix barcode such as a QR code. The QR code may include sales transaction data such as transaction type, terminal ID, transaction number, date/time of transaction, amount of transaction, GPS co-ordinates of the POS terminal 102, merchant ID, among other data. Also, the token generation module 160 may generate the code in a file format that is readable by the POS terminal 102, tap device 140, digital displays 108 or other devices, as discussed above. Furthermore, the token generation module 160 may generate other types of codes such as micro QR code, linear barcodes, other two dimensional barcodes and other codes that are an optical machine readable representation of data. The other types of codes may include less, more or the same amount of information as the QR codes.

Furthermore, the remote server 121 may include a transaction processing module 162 that may communicate with a third party to process the mobile device payment. For example, the transaction processing module 162 may communicate with the consumer's charge authorizing party such as a financial institution 123, a trusted third party associated with the consumer's financial institution, among other parties. The transaction processing module 162 may generate a payment processing record based on the communication with the consumer's authorizing party. In particular, the payment processing record may include specific sales transaction data such as transaction type, Terminal ID, transaction number, date/time of the transaction, amount of transaction, among other data. The payment processing record may be temporarily stored in the account database until the consumer who requested the mobile device payment confirms the details of the transaction as discussed below. If the consumer confirms the details of the transaction, the remote server 121 may store the payment processing record for an extend period of time so the consumer can later retrieve the record.

The remote server 121 may transmit the generated QR code, via Internet 125 and in-store network. The POS terminal 102 and/or electronic cash register may receive the QR code from the remote server 121 and may display the QR code on the digital displays 108. The amount of time the QR code is displayed may be specified in the code or may be set by the display device. For example, the QR code may only be displayed for thirty seconds in order to help reduce the chance of someone else copying the QR code.

Displaying the QR code allows the consumer, who initiated the mobile device payment, to capture an image of the QR code using the mobile device. In particular, the mobile device may include a camera, display and keypad and touch screen as is common in most mobile devices. The camera may be a digital camera. Once the image of the QR code has been captured by the mobile device, i.e., a digital photo is taken of the displayed QR code, the QR code will be decoded by the mobile device. Specifically, the mobile device may have a computer software program, such as a mobile device application, that may decode the QR code or other optical machine readable codes. Specifically, the mobile device application may decode the QR code into sales transaction data that may be displayed to the user on the mobile device display. For example, the mobile device may display the transaction type, Terminal ID, date/time of transaction, amount of transaction, location of the POS terminal 102, among other sales transaction data.

The mobile device application may prompt the user to confirm the displayed sales transaction data. For example, the application may require the user to enter a personal identification number (PIN) in order to link the consumer's account information with the specific sales transaction data. The mobile device application may instruct the mobile device to transmit a confirmation message to the remote server 121 indicating the consumer has approved the transaction. The confirmation message may include instructions instructing the remote server 121 to initiate processing of the mobile device payment with the appropriate entity, i.e., bank. The mobile device may transmit the confirmation message via the mobile carrier network (not shown), in-store network, external network or other networks that may be available to the mobile device, e.g., open wireless networks.

The remote server 121 may receive and process the confirmation message and sales transaction data using secure methods known in the art. For added security, the remote server 121 may process the sales transaction data while offline. In particular, the remote server 121 may search stored consumer account information in order to link the sales transaction data to the consumer requesting the mobile device payment. For example, the remote server 121 may search the consumer account information for a matching mobile phone number and/or PIN. If the remote server 121 does not find the corresponding mobile phone number and/or PIN, the remote server 121 may send a message to the mobile device requesting the user re-enter the appropriate information, i.e., PIN. If the corresponding mobile phone number and/or PIN are found, the remote server 121 may connect to a payment gateway through a secure communication line. The payment gateway allows processing of the payment with the appropriate financial institution 123 or entity. For example, the appropriate entity such as a bank may respond to the remote server 121 by authorizing or declining the payment or may be a trusted third party that maintains a database (credit card vault) which may contain encrypted credit card information of each consumer who has downloaded the mobile payment application of the instant application. The remote server 121 may receive a payment confirmation transmission response (i.e., payment confirmation information message) from the appropriate entity and may forward details of the payment confirmation transmission response to the POS terminal 102, tap device 140, mobile device, among other devices or terminals.

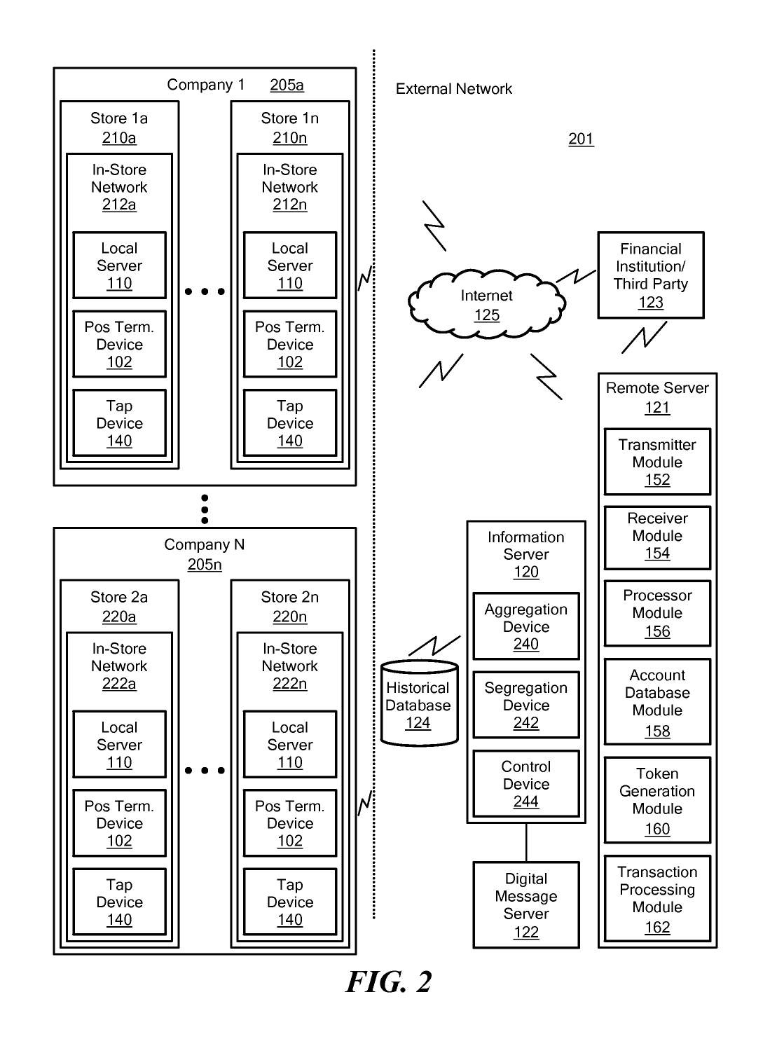

FIG. 2 illustrates exemplary system architecture 200, according to another embodiment of the invention. One or more organizations, such as Company A 205a and Company N 205n, may include a plurality of associated stores. It will be readily understood that “company” may include any organizations having items, such as objects, data, and other items that are intended to be identified collectively. For example, Company A 205a may include a plurality of associated Stores 1a to 1n, identified respectively as 210a-210n. Company N 205n may include a plurality of associated Stores 2a to 2n, identified respectively as 220a-220n. Company A 205a and Company N 205n may include various types of companies, including retail companies, manufacturing companies and entertainment companies, among other company types. Stores 1a to 1n and Stores 2a to 2n may include a plurality of store types, including restaurants, retail stores, among other stores.

According to one embodiment, Stores 1a to 1n and Stores 2a to 2n may have in-store computer networks. For example, Store 1a may include in-store network 212a; Store 1n may include in-store network 212n; Store 2a may include in-store network 222a and Store 2n may include in-store network 222n, among other configurations. The in-store networks illustrated in FIG. 2 include components described above for the in-store network illustrated in FIG. 1. For the sake of brevity, the detailed description of FIG. 2 omits particulars of the digital displays 108, the tap device 140 and the output device 150 described in FIG. 1. One of ordinary skill in the art will readily appreciate that the in-store networks of FIGS. 1 and 2 operate using similar principles.

According to one embodiment, the in-store networks include a POS terminal 102 that is communicatively coupled to one or more local servers 110 and/or to one or more global remote servers, including an information server 120, remote server 121 and a digital message server 122, among other servers. A historical database 124 may be provided to communicate with the remote servers for archiving sales data, among other data. The in-store networks may be communicatively coupled to a plurality of POS terminals 102. The POS terminals 102 may be communicatively coupled to both the corresponding in-store network and to a global external network 201 via a wired network, a wireless network, or a combination of the foregoing and/or other networks, including the Internet 125. The POS terminals 102 may be coupled to an output device 150, such as a printer, imaging device or other output device.

According to one embodiment, the tap device 140 may be positioned between the POS terminal 102 and the output device 150 to monitor and/or capture data passing between these devices, among performing other functions. For example, the tap devices 140 may be positioned between each POS terminal and each output device to monitor and/or capture data passing between these devices. Alternatively, one tap device 140 may be positioned between various POS terminals 102 and output devices 150 to monitor and/or capture data passing between these various devices. The tap devices 140 may operate as unique nodes on the corresponding in-store networks.

The tap devices 140 may be associated with at least one company, including Company A and/or Company N. The tap devices 140 may generate data having header information that includes at least a first unique identifier to associate the data with corresponding stores in which the tap devices 140 are located. The tap devices 140 may further modify the data header information to include at least a second unique identifier that is associated with at least a company that operates or otherwise manages operations of the corresponding tap device 140. One of ordinary skill in the art will readily appreciate that the invention may be implemented using individual identifiers, a single identifier that identifies two or more items, and/or other identifier configurations. Furthermore, the tap devices 140 may modify the data header information to include identifiers associating the tap device 140 with POS terminals 102.

Additionally or alternatively, the tap device 140 may include an automated device that generates identifiers for inclusion in data header information. The identifiers may be affixed to the data header to signify an association between the tap device 140 and one or more of a company, a store and/or POS terminals 102. For example, the tap devices 140 may include a global positioning device that communicates with the processor 143 to generate global positioning data for determining associations between (1) the tap device and the companies, based on a store location, (2) the tap device and the stores, based on a store location, and (3) the tap device and the POS terminals, based on POS terminal location. The tap devices 140 may generate other identifier information to be affixed to the data header. One of ordinary skill in the art will readily appreciate that other techniques may be employed to generate identifier information.

According to one embodiment, the tap devices 140 may capture data obtained from associated POS terminals 102. The tap devices 140 may forward the captured data to the corresponding local server 110 and/or the remote servers, including the information server 120, remote server 121 and the digital message server 122. The remote servers may receive the data captured from tap devices 140 that are located in different stores. The information server 120 may include an aggregation device 240 that aggregates data captured from the tap devices 140 located in different stores that are associated with a same company. Additionally, the remote servers may receive data captured from tap devices 140 located at different stores that are associated with different companies. The remote sever may include substantially the same modules as discussed above with reference to FIG. 1. The captured data includes the unique identifier and identifies at least one store and/or at least one company that are associated with the captured data. The captured data may also include transaction details such as payload identifier, transaction type, terminal ID, transaction number, date/time of transaction, amount of transaction and GPS co-ordinates of POS terminal 102 (e.g., latitude and longitude). The aggregation device 240 merges the captured data into company affiliated data or store data.

The information server 120 and/or the remote server 121 may include a segregation device 242 that segregates data captured from the tap devices 140 associated with different companies. Again, the captured data includes the unique identifier and identifies at least one store and/or at least one company that are associated with the captured data. The segregation device 242 separates the captured data into company affiliated data or store data. The segregation device 242 may communicate with the aggregation device 240 to aggregate data received from different stores that are associated with a same company. The information server 120 and/or remote server 121 include a control device 244 that enables companies to control access to the corresponding company-specific data.

The digital message server 122 delivers digital messages to stores associated with system 200, regardless of a store's company affiliation. To this end, the processor 143 of the tap device 140 may instruct the engine 144 to release corresponding digital messages when the processor 143 finds a match between the received sales transaction data and the digital message trigger data elements that are stored in at least one of the information server 120, the local server 110 or the trigger database 145. The digital messages may be release from the digital message server 122 or the memory device 146, among other sources. Any digital messages released from the digital message server 122 may be routed through the information server 120. The digital messages may be delivered to the local server 110 for processing. The local server 110 may direct the digital messages to the POS terminal 102 and/or the tap device 140 for display by the digital displays 108. If delivered to the POS terminal 102, the digital messages may be displayed to consumers on devices that are communicatively coupled to the POS terminal 102. If delivered to the tap device 140, the digital messages may be displayed to consumers on devices that are communicatively coupled to the tap device 140, but may not be not communicatively coupled to the POS terminal 102. According to one embodiment, the digital displays 108 may provide a matrix barcode, such as a Quick Response (QR) code, that is scanned by a consumer's smart phone. The QR code may result in delivery of selected content to the consumer's smart phone. For example, selected content may be displayed based on find one or more matches between the digital message trigger data elements and the received sales transaction data, as discussed above.

According to one embodiment, digital messages may include content provided to retail consumers at a check out location. Digital messages may include promotional content, advertising content, news content, weather information, product information, service information, promotional materials, discount information for selected products and services or news related to a specific retailer or retail category, among other digital messages. The digital messages may be delivered and displayed in any form, including digital media audio/video files (SWF, AVI, WMF, etc.), static digital images (JPG, GIF, TIF, etc.), dynamic digital images (animated JPG, GIF, etc.), streaming text files and streaming video.

The tap device 140 may include an updating device 151 that updates the sources, including the local server 110, the information server 120 and the digital message server 122, among other sources. The updating device 151 may modify digital message trigger criteria for presenting the digital messages or content associated with product identification codes, manufacturer information, product quantity amounts, purchase price data, payment method data, total value of the sale data, and transaction location, among other preselected digital message trigger data elements.

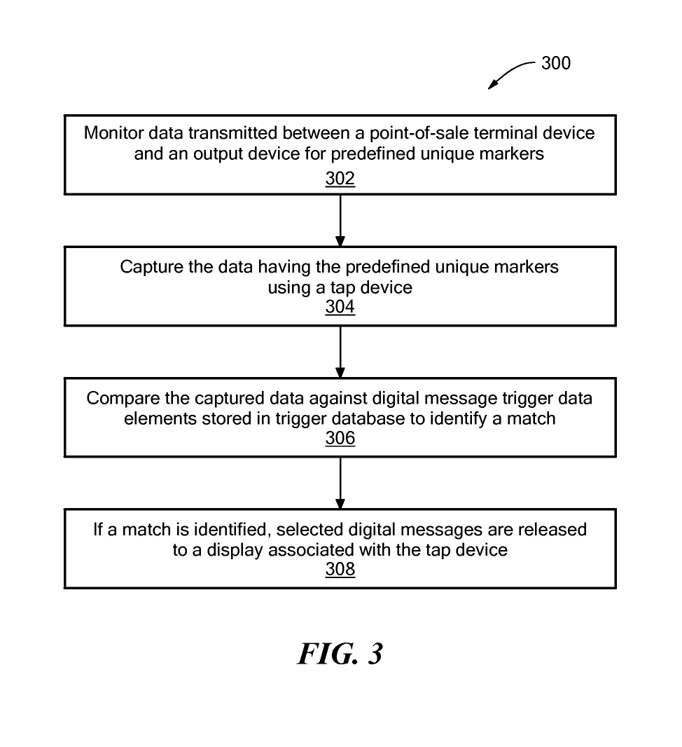

FIG. 3 illustrates a method 300 of automatically delivering digital messages to consumers at the point-of-sale location, without modifying existing point-of-sale systems or electronic cash registers. The method includes monitoring data transmitted between the point-of-service terminal device and an output device for predefined unique markers at step S302. The data having the predefined unique markers is captured using a tap device 140 at step S304. At step S306, the captured data is compared against digital message trigger data elements stored in a trigger database to identify a match between the captured data and the digital message trigger data elements. If a match is identified, selected digital messages are released to a display associated with the tap device 140 in step S308. The selected digital images include a plurality of audio or video file types.

The invention can be realized in hardware, software, or a combination of hardware and software. Any kind of computing system, or other apparatus adapted for carrying out the methods described herein, is suited to perform the functions described herein.

A typical combination of hardware and software could be a specialized computer system having one or more processing elements and a computer program stored on a storage medium that, when loaded and executed, controls the computer system such that it carries out the methods described herein. The invention can also be embedded in a computer program product, which comprises all the features enabling the implementation of the methods described herein, and which, when loaded in a computing system is able to carry out these methods. Storage medium refers to any volatile or non-volatile storage device.

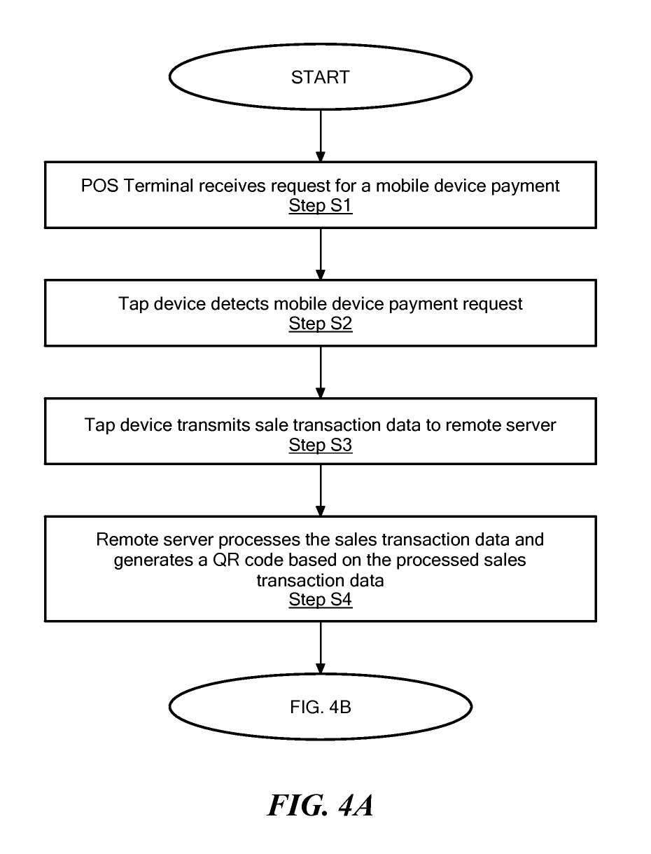

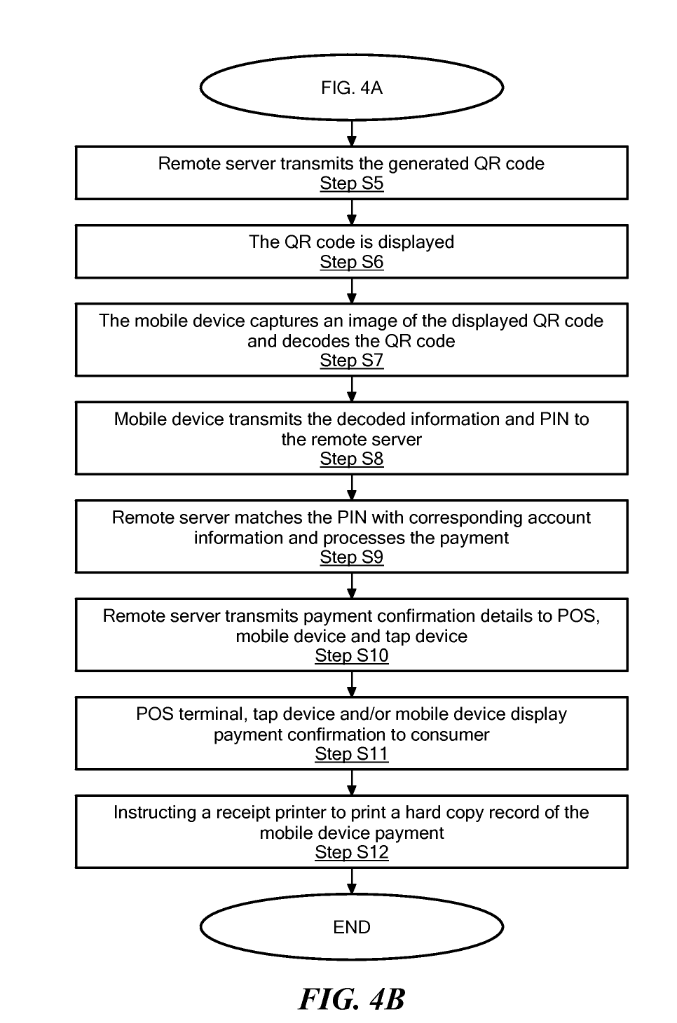

FIGS. 4A, 4B illustrate the method of initiating and processing a mobile device payment at a POS terminal 102. A consumer at a POS terminal 102 indicates he/she wants to pay for goods or services by mobile device payment. (Step S1). For example, the consumer may press a “mobile device payment” button or the like on a POS terminal 102 keypad or touch screen. The tap device 140 that is actively monitoring the POS terminal 102 communications will detect an indicator indicating the consumer at the POS terminal 102 wants to pay by mobile device payment, i.e., detect a specific payload identifier. (Step S2). The tap device 140 transmits the monitored sales transaction data to the remote servers via an in-store network, Internet 125, external network or the like. (Step S3). The remote server 121 processes the received sales transaction data and generates a payment processing record and a QR code based on the processed sales transaction data. (Step S4). The remote server 121 stores the payment processing record in the consumer account database and transmits the generated QR code to the POS terminal 102 and/or the tap device 140. (Step S5). Alternatively, the QR code may be generated at the tap device 140, i.e., skipping steps S3-S4. (not shown). The QR code is displayed on the digital displays 108 and/or another display in order to allow the user to scan the displayed QR code image using a camera such as a mobile phone camera. (Step S5). The scanned (i.e., captured) QR code image is decoded by a mobile phone application that displays some or all of the decoded information on the mobile device display. (Step S7). Displaying some or all of the decoded information allows the consumer to verify the transaction details, e.g., verify total cost of transaction.

The mobile phone application may prompt the consumer to enter a PIN in order to proceed with the transaction. The mobile phone application will instruct the mobile device to transmit the decoded information and PIN to the remote server 121. (Step S8). The transmission of the decoded information and the PIN may occur over the consumer's mobile phone carrier network, in-store network or other networks. Upon receiving the decoded information and the PIN, the remote server 121 searches the consumer account database to match the PIN and/or the mobile phone number (included in the data packet transmission from the mobile device) with a consumer account. (Step S9). If a match is found, the remote server 121 will communicate with the consumer's financial institution 123 to obtain authorization for the transfer of funds, e.g., accept or decline the consumer's credit card. (Step S10). If no match is found, the remote server 121 may transmit a message to the mobile device instructing the mobile device application to ask the consumer to re-enter the PIN. The mobile device may transmit the re-entered PIN to the remote server 121, which may repeat the searching and matching processes of the consumer account database. The remote server 121 will receive payment confirmation information from the consumer's financial institution 123. The remote server 121 will transmit the payment confirmation information to the POS terminal 102, tap device and/or the mobile device. The POS terminal 102 may display the payment confirmation information on the digital displays 108. (Step S11). The tap device may display the payment confirmation information on an associated digital displays 108 or a tap device display. (Step S11). Also, the mobile device may display the payment confirmation information on the mobile device display. (Step S11). The POS terminal 102 and/or the tap device 140 may instruct the receipt printer to print a hard copy record of the transaction indicating a mobile device payment was made. (Step S12).

In other words, the mobile device payment system and method allows a consumer to pay for goods and/or services, at a POS terminal 102, using a mobile device without the need to swipe a credit/debit card or pay cash. In other words, a store having at least one POS terminal 102 may add a tap device 140 in order to allow consumers to pay by mobile phone. As such, integration of the mobile device payment system may not require major hardware and software modifications.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

It will be appreciated by persons skilled in the art that the invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A device for mobile device payment at a point-of-sale (POS) terminal, the device comprising:
a monitor module monitoring at least one communication line of the POS terminal, the monitor module detecting at least one data packet having transaction data;
a trigger database having entries including pre-stored trigger data elements;
a first processor receiving the transaction data and comparing the pre-stored trigger data elements with the transaction data, the first processor generating instructions to transmit the transaction data to a remote server when at least a portion of the transaction data corresponds to at least one pre-selected trigger data element;
a first receiver receiving a Quick Response (QR) code generated by the remote server in response to the transaction data, the QR code including an encoding of the transaction data; and
a display displaying the QR code for image capture by a mobile device that decodes the captured QR code into the transaction data.

2. The device of claim 1, wherein the transaction data includes a payload identifier indicating a mobile device payment transaction.

3. The device of claim 2, wherein the transaction data further includes at least one of a transaction type, terminal identification, transaction number, date of transaction, amount of transaction and Global Positioning System (GPS) co-ordinates of the POS terminal.

4. The device of claim 1, wherein the first receiver receives payment confirmation data from the remote server indicating the remote server processed the mobile device payment.

5. A system for mobile device payment at a point-of-sale (POS) terminal, the system comprising:
a tap device having:
a monitor module monitoring at least one communication line of the POS terminal, the monitor module detecting at least one data packet having transaction data, the transaction data including a payload identifier indicating a mobile device payment transaction;
a trigger database having entries including pre-stored trigger data elements;
a first processor receiving the transaction data and comparing the pre-stored trigger data elements with the transaction data, the first processor generating instructions to transmit the transaction data to a remote server when at least a portion of the transaction data matches at least one pre-selected trigger data element;
a first receiver receiving a token from the remote server responsive to the transmitted transaction data, the token including transaction data; and
a display displaying the token.

6. The system of claim 5, wherein the pre-stored trigger data elements include at least a mobile device payment transaction trigger.

7. The system of claim 5, wherein the first receiver receives payment confirmation data from the remote server indicating the mobile device payment was processed.

8. The system of claim 5, wherein the transaction data further includes at least one of a transaction type, terminal identification, transaction number, date of transaction, amount of transaction and Global Positioning System (GPS) co-ordinates of the POS terminal.

9. The system of claim 5, wherein the remote server includes:
a second receiver receiving transaction data;
a second processor processing the transaction data into the token; and
a transmitter transmitting the token to the tap device.

10. The system of claim 6, wherein the token is a QR code.

11. The system of claim 6, further comprising a mobile device having a camera for capturing the displayed token and a software module for decoding the captured token into transaction data.

12. The system of claim 11, wherein the mobile device displays at least a portion of the decoded token.

13. The system of claim 12, wherein the mobile device receives a personal identification number (PIN) entry and transmits the PIN and decoded token to the remote server.

14. The system of claim 13, wherein the PIN is associated with the decoded token.

15. The system of claim 13, wherein the POS terminal and mobile device receive payment confirmation data from the remote server, the payment confirmation data indicating whether the mobile device payment was declined.

16. A method for mobile device payment at a point-of-sale (POS) terminal device comprising:
monitoring at least one communication line of the POS terminal device;
detecting at least one data packet having transaction data; and
displaying a generated Quick Response (QR) code in response to the transmitted data for image capture, the QR code including an encoding of the transaction data.

17. The method of claim 16, further comprising:
digitally capturing an image of the displayed QR code;
decoding the QR code into decoded QR code data;
linking the decoded QR code data to a personal identification number (PIN); and
transmitting the PIN and decoded QR code data to a remote server.

18. The method of claim 17, further comprising:
receiving the PIN and decoded QR code data;
processing the mobile device payment based on the decoded QR code data and PIN; and
transmitting a status of the processed mobile device payment to the POS terminal.

19. The method of claim 18, further comprising displaying the status of the processed mobile device payment at the POS terminal.

20. The method of claim 19, further comprising instructing a printer at the POS terminal to print a receipt of the mobile device payment.
